(19) United States
(12) Patent Application Publication
(10) Pub. No.: US 2023/0089637 A1
(43) Pub. Date: Mar. 23, 2023

(54) TWIST DRILL BIT

(71) Applicant: APEX BRANDS, INC., Apex, NC (US)

(72) Inventor: LaVerne Royal Durfee, Statesville, NC (US)

(21) Appl. No.: 17/946,424

(22) Filed: Sep. 16, 2022

Related U.S. Application Data
(60) Provisional application No. 63/245,337, filed on Sep. 17, 2021.

(51) Int. Cl. B23B 51/02

(52) U.S. Cl. CPC B23B 51/02; B23B 2251/04; B23B 2251/18; B23B 2251/40

(57) ABSTRACT

A boring tool may include a coupling portion for interfacing with a powered driver, a shank operably coupled to the coupling portion, a cutting portion operably coupled to the shank, and a cutting tip operably coupled to a distal end of the cutting portion relative to the shank. The coupling portion, the shank, the cutting portion and the cutting tip share an axis. The cutting portion may be defined by a plurality of helical cutting flutes that have a variable rate that increases as distance from the cutting tip increases. The shank may include a torsion zone and the cutting tip may include a point angle between about 120 degrees and about 90 degrees.

### TECHNICAL FIELD

Example embodiments generally relate to drilling or boring devices such as drill bits or other tools for forming bore holes in a base material.

### BACKGROUND

Boring or cutting tools, such as drill bits, often have a drive end that includes a conventional interface for receiving drive energy from a powered driving device (e.g., a drill). The drive end may have a standard sized hex head or another conventional drive end geometry that enables the powered driving device to impart rotational force on the boring tool. The boring tool may also have a cutting end at which location a cutting point and/or cutting edges may be formed. By providing rotational energy to the drive end, the cutting end may bore a hole in the material or workpiece on which the boring tool is being used.

A drill bit is one example of a boring tool that has been around a long time, and remains an extremely useful component to many tool kits. Most drill bits have helical shaped cutting flutes that extend across a cutting portion thereof, from a tip of the drill bit toward a shank of the drill bit. In this familiar context, the tip of the drill bit typically has a point that can be distinguished by the angle of the point (or point angle). There are two common point angles (namely 118 degrees and 135 degrees) that are employed on bits that are tailored to specific purposes suited to whichever one of the angles is selected. In the past, one of these point angles would be selected prior to machining the drill bit depending on the expected use of the drill bit, and the tip would be machined at the corresponding selected angle. The resultant drill bit would be specialized to either harder or softer materials according to the angle selected. However, it may be desirable to have a single bit that can achieve superior performance over usage with many different types of materials.

### BRIEF SUMMARY OF SOME EXAMPLES

According to some example embodiments, an example boring tool is provided. The boring tool may include a coupling portion for interfacing with a powered driver, a shank operably coupled to the coupling portion, a cutting portion operably coupled to the shank, and a cutting tip operably coupled to a distal end of the cutting portion relative to the shank. The coupling portion, the shank, the cutting portion and the cutting tip share an axis. The cutting portion may be defined by a plurality of helical cutting flutes that have a variable rate that increases as distance from the cutting tip increases. The shank may include a torsion zone and the cutting tip comprises a point angle between about 120 degrees and about 90 degrees.

According to some example embodiments, a method of forming a boring tool is provided. The method may include machining the boring tool such that the boring tool includes a coupling portion, a cutting tip, a shank, and a cutting portion sharing an axis. The method may further include machining the cutting portion to define helical cutting flutes that extend from the cutting tip to the shank, machining a torsion zone in the shank, and machining the cutting tip to define a point angle between about 120 degrees and about 90 degrees. The helical cutting flutes may have a variable rate that increases as distance from the cutting tip increases.

According to another example embodiment, a boring tool is provided. The boring tool may include a coupling portion for interfacing with a powered driver, a shank operably coupled to the coupling portion, a cutting portion operably coupled to the shank, and a cutting tip operably coupled to a distal end of the cutting portion relative to the shank. The coupling portion, the shank, the cutting portion and the cutting tip share an axis. The cutting portion may be defined by a plurality of helical cutting flutes that have a variable rate that increases as distance from the cutting tip increases. The shank may include a portion having a reduced diameter that is 80% to 95% of a diameter of other portions of the shank to absorb shock from the powered driver and the cutting tip may include a point angle between about 110 degrees and about 100 degrees.

### BRIEF DESCRIPTION OF THE SEVERAL VIEWS OF THE DRAWING(S

Having thus described some example embodiments in general terms, reference will now be made to the accompanying drawings, which are not necessarily drawn to scale, and wherein:

FIG. 1 illustrates a perspective view of a boring tool according to an example embodiment;

FIG. 2 illustrates a side view of the boring tool of FIG. 1 according to an example embodiment;

FIG. 3 illustrates a cross section view through an axis of the boring tool of FIG. 1 according to an example embodiment;

FIG. 4 illustrates a perspective view of a cutting tip of the boring tool of FIG. 1 according to an example embodiment;

FIG. 5 illustrates a side view of the cutting tip of the boring tool of FIG. 1 according to an example embodiment;

FIG. 6 illustrates a top view of the cutting tip of the boring tool of FIG. 1 according to an example embodiment; and

FIG. 7 illustrates a block diagram of a method of forming a boring tool according to an example embodiment.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable legal requirements. Like reference numerals refer to like elements throughout. Furthermore, as used herein, the term “or” is to be interpreted as a logical operator that results in true whenever one or more of its operands are true. As used herein, operable coupling should be understood to relate to direct or indirect connection that, in either case, enables functional interconnection of components that are operably coupled to each other.

As indicated above, it may be desirable to obtain a drill bit that can be used without disadvantage across multiple different materials. It would be further desirable if a drill bit could be developed that could be used both with a conventional drill, and with an impact driver. Some example embodiments may relate to the provision of a boring tool (e.g., a drill bit) with features that provide superior performance across multiple materials and multiple drivers. In an example embodiment, the boring tool may be constructed in such a way as to integrate a more acutely angled cutting point than conventional designs in combination with a variable helix flute design and a torsion zone. The combination of these features described herein provides the unique capability to create a general purpose twist drill bit that can perform well in numerous different contexts. Some structures that can employ example embodiments will now be described below by way of example and not limitation.

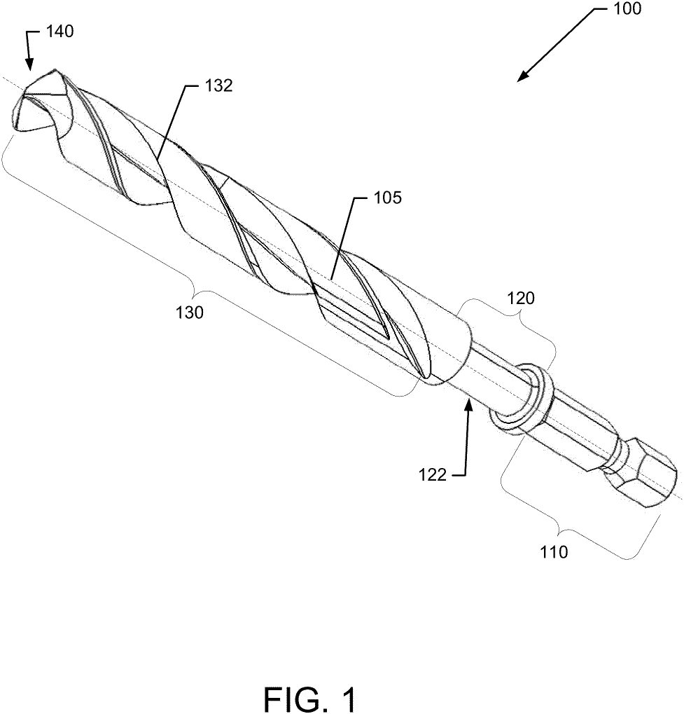

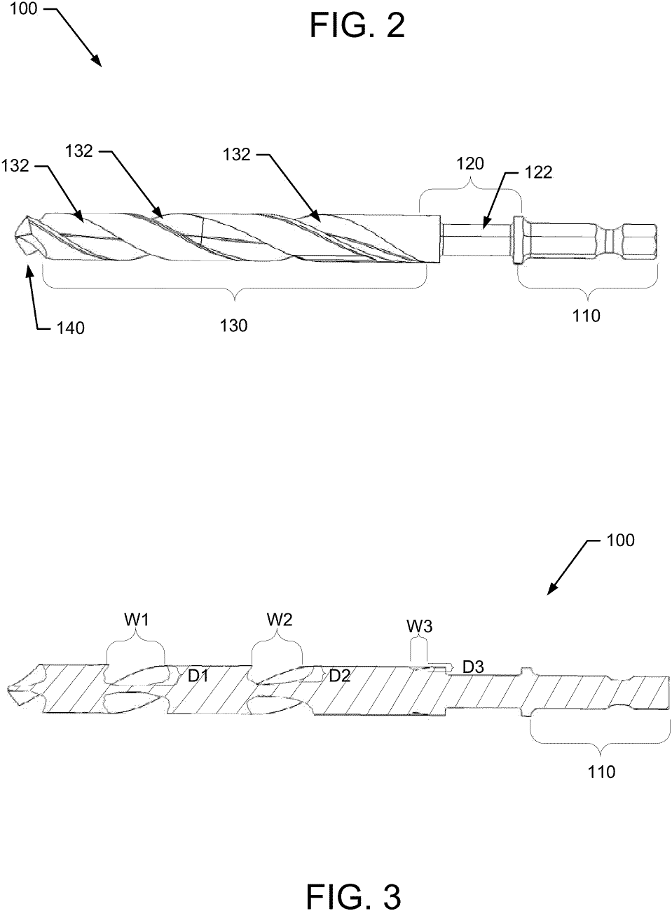

FIG. 1 illustrates a perspective view of a drill bit 100 according to an example embodiment, as one example of a boring tool. FIG. 2 illustrates a side view of the drill bit 100 of FIG. 1, and FIG. 3 shows a cross section view taken along an axis 105 of the drill bit 100. Referring to FIGS. 1-3, it can be seen that the drill bit 100 may include a coupling portion 110, a shank 120, a cutting portion 130 and a cutting tip 140 disposed at the distal end of the cutting portion 130. The coupling portion 110, the shank 120, the cutting portion 130 and the cutting tip 140 may all share a common axis (i.e., axis 105) that extends longitudinally through a middle of the drill bit 100. The coupling portion 110, the shank 120, the cutting portion 130 and the cutting tip 140 shown in FIGS. 1-3 may be varied in certain ways in alternative embodiments without departing from the scope of embodiments of the present invention. However, all such alternative embodiments include the combination of features (albeit to varying degrees) described in greater detail below.

The coupling portion 110 may be configured to operably couple the drill bit 100 to an external device that may provide torque to the drill bit 100. In this regard, the coupling portion 110 may be a part of the drill bit 100 that receives a torque force. In some embodiments, the device may be a handheld power tool such as a conventional pneumatic, electric, or battery powered drill. However, in other embodiments, the device may be an impact driver. In some embodiments, the coupling portion 110 of the drill bit 100 may be configured to have a non-circular outer surface to facilitate translating torque from the device to the drill bit 100. For example, the coupling portion 110 may have a hexagonally shaped cross section to facilitate engagement with the driving device, such as with a chuck of a drill, or a ¼ inch hex socket driver. Thus, although FIGS. 1-3 show the coupling portion 110 as a ¼ inch hex coupler, it should be appreciated that, in some cases, the coupling portion 110 may be cylindrical in shape, and thus have a circular cross section.

The shank 120 may operably couple the coupling portion 110 to the cutting portion 130. Thus, the shank 120, may assist with translating torque from receiving devices into rotational motion of the cutting portion 130. The shank 120 may have a proximal end that may be operably coupled to a distal end of the coupling portion 110. In this regard, the terms proximal and distal may be relative to the driving device when the drill bit 100 is attached thereto. The cutting portion 130 may be operably coupled to a distal end of the shank 120 at a proximal end of the cutting portion 130. The shank 120 may therefore be understood to transfer torque applied at the coupling portion 110 (by the driving device) to the cutting portion 130. Therefore, the shank 120 may be subjected to high torsional loading due to the shank 120 forming a connection between the coupling portion 110 and the cutting portion 130, both of which may experience opposing forces while the drill bit 100 is in use. In this regard, the driving device may exert a torque on the coupling portion 110 that may be opposed due to the direction of rotation of the drill bit 100 by the friction generated by the cutting portion 130 with the material being cut. Thus, these opposing forces may be naturally distributed throughout the drill bit 100.

The shank 120 may typically have a consistent or same diameter between the proximal and distal ends thereof for a conventional drill bit. However, in the example of FIGS. 1-3, the shank 120 is provided with one portion, or zone, that has a smaller diameter than other portions of the shank 120. This portion or zone may be referred to as a torsion zone 122. The torsion zone 122 may be a portion of the shank 120 having a diameter that is reduced in size relative to surrounding portions thereof. In various examples, the diameter of the torsion zone 122 may be anywhere from 80% to 95% of a diameter of the other portions of the shank 120. The reduced diameter of the torsion zone 122 may provide for a zone in which additional twisting and heat generation and release may be accomplished to improve the performance of the drill bit 100. The torsion zone 122 may be particularly useful as a shock absorber for use with an impact driver. Thus, the torsion zone 122 may play a key role in providing the drill bit 100 with the capability to be used effectively with different driving devices (and particularly enabling cross utility by enabling use with an impact driver).

The cutting portion 130 of an example embodiment may include a plurality of helical cutting flutes 132 that extend from the cutting tip 140 at the distal end of the cutting portion 130 to the shank 120 at the proximal end of the cutting portion 130. The cutting flutes 132 of an example embodiment are formed to have a variable helix. As such, for example, the rate of turn on the helical cutting flutes 132 increases as distance from the cutting tip 140 increases. Thus, for example, the speed of the helix increases as distance from the cutting tip 140 increases. In the example of FIGS. 1-3, two cutting flutes 132 are provided. However, it is possible to include more cutting flutes in alternative embodiments. It should also be appreciated that the rate of turn may increase linearly or non-linearly. Width and depth of the grooves provided in the cutting flutes 132 also decrease as distance increases from the cutting tip 140 in an example embodiment. In this regard, for example, FIG. 3 shows a progression of depths as D1 is greater than D2, which is greater than D3, and a progression of widths as W1 is greater than W2, which is greater than W3.

The formation of the cutting flutes 132 as described above, gives the cutting flutes 132 (and the drill bit 100 as a whole) improved characteristics, and design flexibility. In this regard, the variable helix of the cutting flutes 132 will generally assist in forming and transporting chips or other material (e.g., swarf) released by the cutting action of the drill bit 100 out of the hole drilled. Accordingly, swarf may effectively be removed from deeper holes, thereby improving drill bit 100 performance in thicker materials (instead of only enabling performance in drilling through thin sheets or other thinner materials where a full through hole can be formed).

Meanwhile, the cutting tip 140, rather than having a conventional 118 degree or 135 degree point angle, may be formed to have a more acute angle (e.g., relative to the axis 105). In this regard, example embodiments may employ a significantly acute point angle relative to the axis 105, and the point angle 160 measured from face to face on opposite sides of the axis 105 may be in a range of between about 120 degrees to 90 degrees. Moreover, in some embodiments, the point angle 160 may be less than 115 degrees. In an example embodiment, the point angle 160 may be selected between an angle of 100 and 110 degrees.

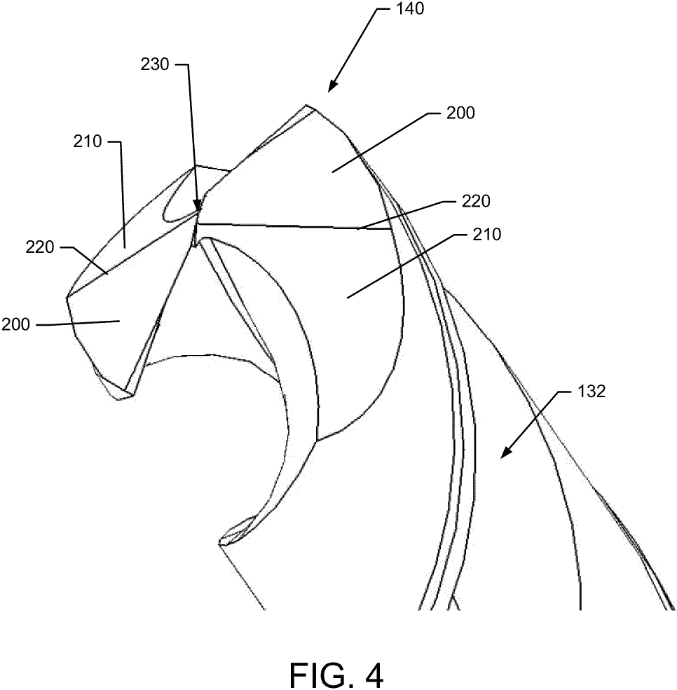

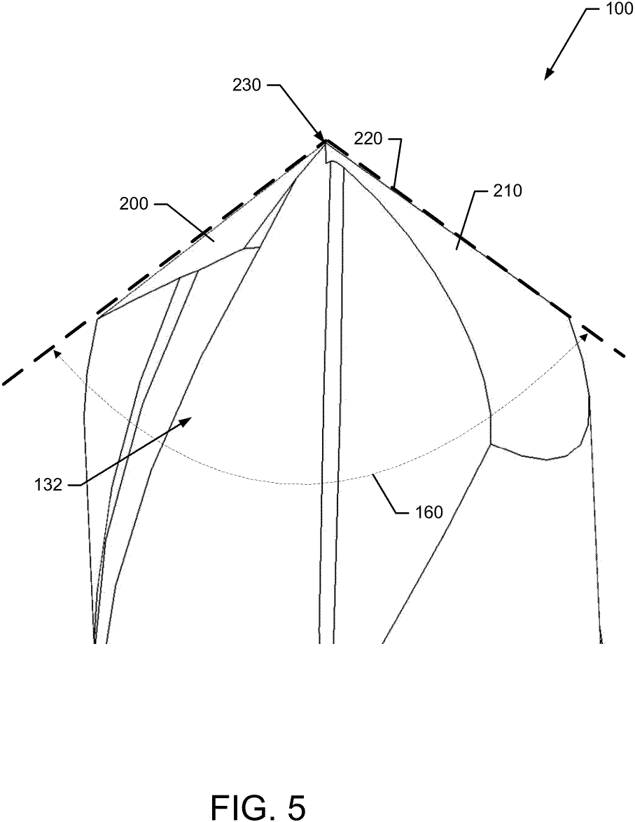

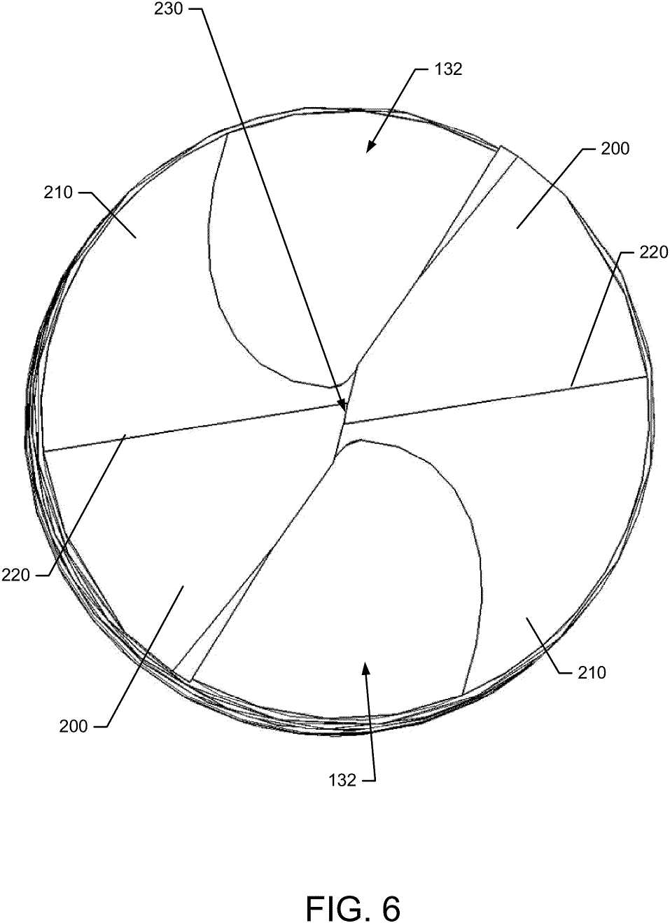

FIGS. 4-6 illustrate the cutting tip 140 of an example embodiment in greater detail. In this regard, FIG. 4 is a perspective view of the cutting tip 140, and FIG. 5 is a side view showing the point angle 160 measurement in detail. Meanwhile, FIG. 6 is a front view of the drill bit 100 looking down the axis 105 at the cutting tip 140.

Referring to FIGS. 4-6, the cutting tip 140 can be seen to include a first angled face 200 and a second angled face 210 disposed between each of the cutting flutes 132. Thus, two instances of each of the first angled face 200 and the second angled face 210 are provided since there are two cutting flutes 132 in this example. The first angled face 200 may be provided at a leading (or cutting) edge that engages the material being cut by the drill bit 100 to create swarf and funnel the swarf through the grooves of the cutting flutes 132. The second angled face 210 may be formed behind the first angled face 200 relative to the direction of rotation for cutting/drilling.

The first and second angled faces 200 and 210 are angled relative to each other and to the axis 105. The intersection of the first and second angled faces 200 and 210 therefore forms a ridge 220 in profile that extends at an acute angle away from the axis 105. The point angle 160 may be measured between the ridges 220 formed by each of the intersections between the two pairs of first and second angled faces 200 and 210 that are provided between each of the cutting flutes 132. However, the point angle 160 may also be measured between the first and second angled faces 200 and 210 as well in some cases.

As can be appreciated from FIG. 6, a diameter of the drill bit 100 increases slightly as distance from the cutting tip 140 increases. Moreover, since the variable helix of the cutting flutes 132 may also have shallower grooves as distance from the cutting tip 140 increases, the strength of the cutting portion 130 of the drill bit 100 may increase as proximity to the driving device decreases since the thickness of metal at the core of the drill bit 100 thickens as proximity to the shank 120 decreases.

As shown particularly in FIGS. 4 and 6, the ridges 220 may not actually meet each other at a single point. Instead, the ridges 220 between the first and second faces 200 and 210 of opposing sides of the cutting tip 140 may be offset from each other. In other words, a cutting point of the cutting tip 140 may be split, thereby forming split point 230. The splitting of the cutting point may provide certain additional benefits in performance to the drill bit 100. In this regard, for example, employing the split point 230 may enable the cutting tip 140 to perform a web thinning operation to help the cutting point of the cutting tip 140 start in any material with less pressure applied.

By employing the variable helix along with a torsion zone, and a more acute cutting point, a drill bit that can perform well in materials of all types including wood, plastic, nonferrous materials, mild steels, and/or the like, may be provided. The split point also enables easier starting without having the drill bit wander or move on the surface of the material being drilled, and the variable helix allows deep holes to be drilled with ease. Moreover, the torsion zone further enables usage of the drill bit with an impact driver in addition to conventional twist drills.

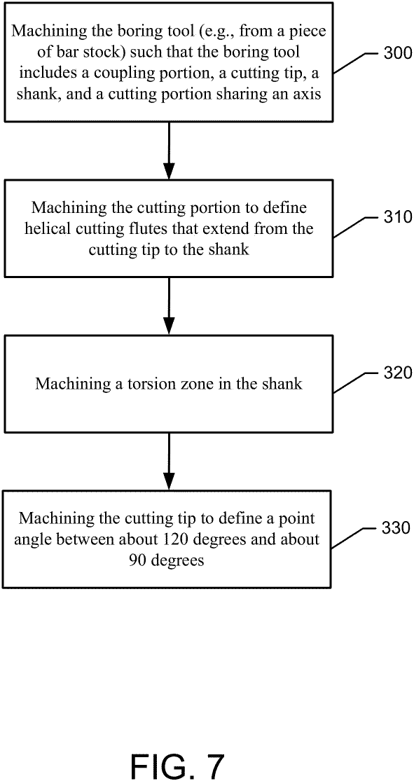

FIG. 7 shows a block diagram of a method of making a boring tool in accordance with an example embodiment. As shown in FIG. 7, the method may include machining the boring tool (e.g., from a piece of bar stock) such that the boring tool includes a coupling portion, a cutting tip, a shank, and a cutting portion sharing an axis at operation 300. The method may further include machining the cutting portion to define helical cutting flutes that extend from the cutting tip to the shank at operation 310, machining a torsion zone in the shank at operation 320, and machining the cutting tip to define a point angle between about 120 degrees and about 90 degrees at operation 330. The helical cutting flutes may have a variable rate that increases as distance from the cutting tip increases.

Although not required, the method described above may be modified, or additional operations may be included. Some example modifications are described below, and may be combined with each other in any suitable combination. In this regard, for example, machining the cutting tip may include machining a split point at the cutting tip. In an example embodiment, machining the cutting tip may include machining a first face and a second face each extending away from the axis. The first and second faces may be disposed between adjacent grooves of the helical cutting flutes, and the first and second faces may meet at a ridge that extends linearly away from the axis at an acute angle relative to the axis. In some cases, the ridges may be offset from each other to form the split point. In an example embodiment, machining the torsion zone may include grinding a portion of the shank having a reduced diameter relative to other portions of the shank, and the reduced diameter may be between about 80% to about 95% of a diameter of the other portions of the shank. In some cases, machining the cutting portion may include forming a depth of grooves of the helical cutting flutes to decrease as distance from the cutting tip increases. In an example embodiment, machining the cutting portion may include forming a width of the grooves of the helical cutting flutes to decrease as distance from the cutting tip increases. In some cases, the coupling portion is a ¼ inch hex head.

Some example embodiments may therefore provide a boring tool or drill bit. The boring tool may include a coupling portion for interfacing with a powered driver, a shank operably coupled to the coupling portion, a cutting portion operably coupled to the shank, and a cutting tip operably coupled to a distal end of the cutting portion relative to the shank. The coupling portion, the shank, the cutting portion and the cutting tip share an axis. The cutting portion may be defined by a plurality of helical cutting flutes that have a variable rate that increases as distance from the cutting tip increases. The shank may include a torsion zone and the cutting tip comprises a point angle between about 120 degrees and about 90 degrees.

The boring tool of some embodiments may include additional features, modifications, augmentations and/or the like to achieve further objectives or enhance performance of the boring tool. The additional features, modifications, augmentations and/or the like may be added in any combination with each other. Below is a list of various additional features, modifications, and augmentations that can each be added individually or in any combination with each other. For example, the point angle of the cutting tip is less than 115°. In an example embodiment, the cutting tip may further include a split point. In some cases, the cutting tip may include a first face and a second face each extending away from the axis. The first and second faces may be disposed between adjacent grooves of the helical cutting flutes, and the first and second faces may meet each other at a ridge that extends linearly away from the axis at an acute angle relative to the axis. In an example embodiment, the ridges may be offset from each other to form the split point. In some cases, the torsion zone may include a portion of the shank having a reduced diameter relative to other portions of the shank to absorb shock from an impact driver. In an example embodiment, the reduced diameter may be between about 80% to about 95% of a diameter of the other portions of the shank. In some cases, a depth of grooves of the helical cutting flutes may decrease as distance from the cutting tip increases. In an example embodiment, a width of grooves of the helical cutting flutes may decrease as distance from the cutting tip increases. In some cases, the coupling portion may be a ¼ inch hex head. In an example embodiment, the variable rate may be a linear or nonlinear increase.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to problems are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

That which is claimed:

1. A boring tool comprising:
a coupling portion for interfacing with a powered driver;
a shank operably coupled to the coupling portion;
a cutting portion operably coupled to the shank; and
a cutting tip operably coupled to a distal end of the cutting portion relative to the shank,
wherein the coupling portion, the shank, the cutting portion and the cutting tip share an axis,
wherein the cutting portion is defined by a plurality of helical cutting flutes that have a variable rate that increases as distance from the cutting tip increases,
wherein the shank comprises a torsion zone; and
wherein the cutting tip comprises a point angle between about 120 degrees and about 90 degrees.

2. The boring tool of claim 1, wherein the point angle of the cutting tip is less than 115°.

3. The boring tool of claim 1, wherein the cutting tip further comprises a split point.

4. The boring tool of claim 2, wherein the cutting tip comprises a first face and a second face each extending away from the axis, wherein the first and second faces are disposed between adjacent grooves of the helical cutting flutes, and wherein the first and second faces meet at a ridge that extends linearly away from the axis at an acute angle relative to the axis.

5. The boring tool of claim 1, wherein the torsion zone comprises a portion of the shank having a reduced diameter relative to other portions of the shank to absorb shock from an impact driver.

6. The boring tool of claim 5, wherein the reduced diameter is between about 80% to about 95% of a diameter of the other portions of the shank.

7. The boring tool of claim 1, wherein a depth of grooves of the helical cutting flutes decreases as distance from the cutting tip increases.

8. The boring tool of claim 8, wherein a width of grooves of the helical cutting flutes decreases as distance from the cutting tip increases.

9. The boring tool of claim 1, wherein the coupling portion is a ¼ inch hex head.

10. The boring tool of claim 1, wherein the variable rate is a linear increase.

11. The boring tool of claim 1, wherein the variable rate is a nonlinear increase.

12. A method of making a boring tool, the method comprising:
machining the boring tool such that the boring tool includes a coupling portion, a cutting tip, a shank, and a cutting portion sharing an axis;
machining the cutting portion to define helical cutting flutes that extend from the cutting tip to the shank;
machining a torsion zone in the shank; and
machining the cutting tip to define a point angle between about 120 degrees and about 90 degrees,
wherein the helical cutting flutes that have a variable rate that increases as distance from the cutting tip increases.

13. The method of claim 12, wherein machining the cutting tip further comprises machining a split point at the cutting tip.

14. The method of claim 13, wherein machining the cutting tip comprises machining a first face and a second face each extending away from the axis, wherein the first and second faces are disposed between adjacent grooves of the helical cutting flutes, and wherein the first and second faces meet at a ridge that extends linearly away from the axis at an acute angle relative to the axis.

15. The method of claim 13, wherein machining the torsion zone comprises grinding a portion of the shank having a reduced diameter relative to other portions of the shank, and
wherein the reduced diameter is between about 80% to about 95% of a diameter of the other portions of the shank.

16. The method of claim 13, wherein machining the cutting portion comprises forming a depth of grooves of the helical cutting flutes to decrease as distance from the cutting tip increases.

17. The method of claim 16, wherein machining the cutting portion comprises forming a width of the grooves of the helical cutting flutes to decrease as distance from the cutting tip increases.

18. A boring tool comprising:
a coupling portion for interfacing with a powered driver;
a shank operably coupled to the coupling portion;
a cutting portion operably coupled to the shank; and
a cutting tip operably coupled to a distal end of the cutting portion relative to the shank,
wherein the coupling portion, the shank, the cutting portion and the cutting tip share an axis,
wherein the cutting portion is defined by a plurality of helical cutting flutes that have a variable rate that increases as distance from the cutting tip increases,
wherein the shank comprises a portion having a reduced diameter that is 80% to 95% of a diameter of other portions of the shank to absorb shock from an impact driver; and
wherein the cutting tip comprises a point angle between about 110 degrees and about 100 degrees.

19. The boring tool of claim 18, wherein the cutting tip further comprises a split point.

20. The boring tool of claim 19, wherein the cutting tip comprises a first face and a second face each extending away from the axis, wherein the first and second faces are disposed between adjacent grooves of the helical cutting flutes, and wherein the first and second faces meet at a ridge that extends linearly away from the axis at an acute angle relative to the axis.
